(19) United States
(12) Patent Application Publication
(10) Pub. No.: US 2014/0357305 A1
(43) Pub. Date: Dec. 4, 2014

(54) ORIENTATION OF MOBILE DEVICE MEASURING EARTH'S MAGNETIC FIELD INDOORS

(71) Applicant: INDOORATLAS OY, Oulu (FI)

(72) Inventors: Janne HAVERINEN, Kiviniemi (FI); Mikko PERTTUNEN, Oulu (FI); Jaakko SUUTALA, Oulu (FI)

(73) Assignee: INDOORATLAS OY, Oulu (FI)

(21) Appl. No.: 13/905,655

(22) Filed: May 30, 2013

(51) Int. Cl. H04W 4/02

(52) U.S. Cl. CPC H04W 4/026
USPC 455/456.6

(57) ABSTRACT

There is provided an apparatus configured to: acquire Earth's magnetic field, EMF, measurement results indicating the EMF measured by a mobile device in a building, wherein the EMF measurements are performed by the mobile device in an unknown three-dimensional orientation in a three-dimensional coordinate system of a person carrying the mobile device along a movement direction of the person; acquire motion data of the mobile device, wherein the motion data is measured by at least one inertial measurement unit comprised in the mobile device; determine at least one angle estimate of a difference between the three-dimensional orientation of the mobile device and at least one dominant movement direction on the basis of at least one feature related to the at least one dominant movement direction of the mobile device; and adjust the acquired EMF measurement results on the basis of the determined at least one angle estimate.

### FIELD

The invention relates generally to indoor positioning systems. More particularly, the invention relates to compensating for the unknown orientation of a mobile device measuring Earth's magnetic field indoor.

### BACKGROUND

It may be of importance to track person's movements when the person is inside a building. However, a well-known outdoor positioning system employing a global positioning system (GPS) or any other satellite based system may not work inside a building due to lack of reliable reception of satellite coverage. Therefore, a positioning technique utilizing Earth's magnetic fields (EMF) indoors has been developed as one possible option for indoor location discovery. However, for the application of a direction of the EMF in location estimation and/or tracking, it is important that the three-dimensional orientation of the mobile device is determined quickly, with a low computational complexity and reliably.

### BRIEF DESCRIPTION OF THE INVENTION

According to an aspect of the invention, there is provided an apparatus as specified in claim 1.

According to an aspect of the invention, there is provided a method as specified in claim 15.

According to an aspect of the invention, there is provided a computer program product as specified in claim 16.

According to an aspect of the invention, there is provided a computer-readable distribution medium carrying the above-mentioned computer program product.

According to an aspect of the invention, there is provided an apparatus comprising means for performing any of the embodiments as described in the appended claims.

Embodiments of the invention are defined in the dependent claims.

### LIST OF DRAWINGS

In the following, the invention will be described in greater detail with reference to the embodiments and the accompanying drawings, in which

FIG. 1 presents a floor plan of a building;

FIGS. 2A to 2C show a positioning device and an example measured magnetic field vector;

FIG. 3A shows a method according to an embodiment;

FIG. 3B shows a person carrying a mobile device in an unknown three-dimensional orientation, according to an embodiment;

FIGS. 4A to 4C illustrate different orientations of the mobile device;

FIGS. 5A and 5B show determining the three-dimensional orientation of the mobile device according to an embodiment;

FIGS. 6A, 6B, 7A, 7B and 8A to 8D show determining the three-dimensional orientation of the mobile device according to another embodiment;

FIGS. 9A and 9B illustrate acquisition of reference motion data, according to some embodiments;

FIG. 10 illustrates some embodiments in which determined stability of the mobile device is applied; and

FIGS. 11 and 12 illustrate apparatuses according to embodiments.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In order to enable positioning, a GPS based location discovery and/or tracking is known. The GPS location discovery may not, however, be suitable for indoors due to lack of satellite reception coverage. For indoor based location tracking, RF based location discovery and location tracking may be used. In such system, a round trip time of the RF signal, or the power of the received RF signal, for example, may be determined to an indoor base station to which the user device is connected to. However, he coverage area of one base station may be wide resulting in poor accuracy. Also multipath propagation, unpredictable objects, etc. may affect the accuracy in a negative manner. Some other known positioning measures, which may be applicable indoors, include machine vision, motion sensor and distance measuring, for example. However, these may require expensive measuring devices and equipment mounted throughout the building. As a further option, the utilization of Earth's magnetic field (EMF) may be applied.

The material used for constructing the building may affect the EMF measurable in the building and also the EMF surrounding the building. For example, steel, reinforced concrete, and electrical systems may affect the EMF. The EMF may vary significantly between different locations in the building and may therefore enable accurate location discovery and tracking inside the building based on the EMF local deviations inside the building. On the other hand, the equipment placed in a certain location in the building may not affect the EMF significantly compared to the effect caused by the building material, etc. Therefore, even if the layout and amount of equipment and/or furniture, etc., change, the measured EMF may not change significantly.

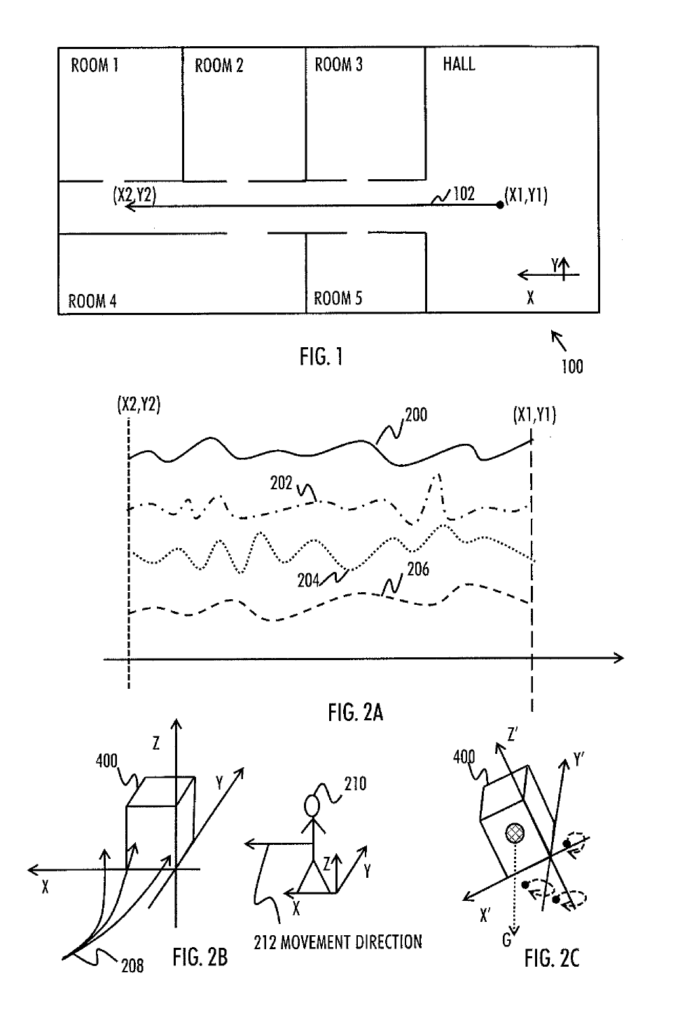

An example of a building 100 with 5 rooms, a corridor and a hall is depicted in FIG. 1. It is to be noted that the embodiments of the invention are also applicable to other type of buildings, including multi-floor buildings. In FIG. 1, the arrow starting at a point (X1, Y1) and ending at a point (X2, Y2) may be seen as a path 102 traversed by a user associated with an EMF positioning device. The vertical Z dimension is omitted for simplicity.

The mobile device is detailed later, but for now it may be said, that the mobile device may comprise a magnetometer or any other sensor capable of measuring the EMF, such as a Hall sensor or a digital compass. The magnetometer may comprise at least one orthogonal measuring axis. However, in an embodiment, the magnetometer may comprise three-dimensional measuring capabilities. Yet in one embodiment, the magnetometer may be a group magnetometer, or a magnetometer array which provides magnetic field observation simultaneously from multiple locations spaced apart. The magnetometer may be an accurate sensor capable to detect any variations in the EMF. In addition to the strength, also known as magnitude, intensity or density, of the magnetic field (flux), the magnetometer may be capable of determining a three-dimensional direction of a measured EMF vector. To this end, it should be noted that at any location, the Earth's magnetic field can be represented by a three-dimensional vector. Let us assume that a compass needle is tied at one end to a string such that the needle may rotate in any direction. The direction the needle points, is the direction of the Earth's magnetic field vector.

The magnetometer carried by a person in the mobile device traversing the path 102 in FIG. 1 is capable of determining the three-dimensional magnetic field vector. Example three components of the EMF vector as well as the total strength are shown in FIG. 2A throughout the path 102 from (X1, Y1) to (X2, Y2). The solid line 200 may represent the total strength of the magnetic field vector and the three other lines 202 to 206 may represent the three component of the three dimensional magnetic field vector. For example, the dot-dashed line 202 may represent the Z component (vertical component), the dotted line 204 may represent the X component, and the dashed line 206 may represent the Y component. From this information, the magnitude and direction of the measured magnetic field vector may be extracted.

In location tracking/discovery of positioning device, or any target object moving in the building 100, each EMF vector measured by the mobile device carried by a person may be compared to existing information, wherein the information may comprise EMF vector strength and/or direction in several locations within the building 100 or within a plurality of buildings. The information may thus depict an indoor Earth's magnetic field map. The EMF map may be stored in a database entity or an entity instead of the mobile device having limited computational capabilities. The positioning device may thus transmit each EMF measurement result to the database entity in a network, i.e. to a cloud, which performs the comparison against the EMF map. As a result, the database entity may then return a location estimate to the positioning device. Alternatively, the EMF map is stored in the mobile device which may then itself perform the location estimation/tracking.

FIG. 2B shows how the Earth's magnetic field 208 may be present at the location of the mobile device, MD, 400. In FIG. 2B, the MD 400 is oriented in the three-dimensional (3D) space (X, Y, Z) according to the frame of reference (coordinate system) of a person 210 carrying the MD 400. It should be noted that the EMF map may comprise vector values (such as magnitude and direction related values) which correspond to values when the mobile device 400 is kept in a mapping-specific 3D orientation defined in the frame of reference (X, Y, Z) of the person 210. For example, this mapping-specific 3D orientation may correspond to an orientation in which one side (front side) of the mobile device 400 is constantly pointed towards a moving direction 212 of the person 210 carrying the mobile device 400. For example, the position of FIG. 2B may represent this mapping-specific position. It should be noted that although observing the magnitude may in some cases be sufficient for detecting the change of the operational environment and/or for the location estimation/tracking, observing the direction may provide additional accuracy and efficiency. This is because more information, including the direction or sub-components, may be utilized.

However, a person carrying the mobile device 400 may not all the time keep the mobile device 400 in correct angles with respect to the mapping-specific 3D orientation. In particular, the mobile device 400 may be rotated about at least one of the three axis X, Y and Z, as show in FIG. 2C. In this case, the 3D frame of reference is not for the person 210 but for the MD 400. Such frame of reference (e.g. coordinates) may be denoted with X′, Y′, and Z′ corresponding to rotated X, Y, and Z of the person's 3D coordinate system. The G vector in FIG. 2C denotes the gravitational force experienced by the MD 400. Such orientation uncertainty may lead to inaccurate EMF measurements being carried out by the mobile device 400 and, thus, lead to erroneous or inefficient location discovery and/or tracking or to an erroneous or a non-optimal initial location estimate. Therefore, adjusting/rotating/correcting/compensating the acquired EMF vector from the frame of reference (X′, Y′, Z′) of the mobile device 400 to a known coordinate system, such as to the frame of reference (X, Y, Z) of the person 210, i.e. to the mapping-specific 3D orientation, may be important.

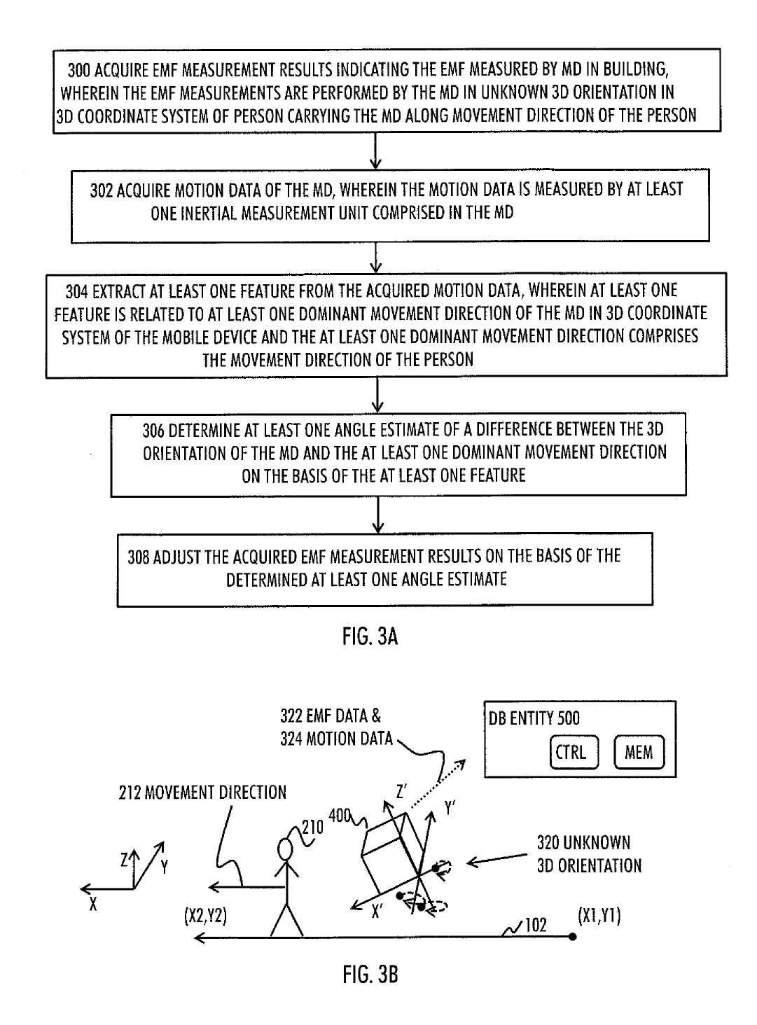

Therefore, it is proposed, as shown in FIGS. 3A and 3B, that the database (DB) entity 500, in step 300, acquires (e.g. receives) EMF measurement results 322 indicating the EMF measured by the MD 400 in the building 100, wherein the EMF measurements are performed while the MD 400 is in an unknown 3D orientation 320 in a 3D coordinate system (X, Y, Z) of the person 210 carrying the MD 400 along a movement direction 212 of the person 210. The EMF results 322 may be obtained by applying the magnetometer of the MD 400. Throughout the specification, the movement/moving direction 212 of the person 210 is assumed to be parallel with the X-axis in the 3D coordinate system of the person 210. It should be noted that although the rest of the specification assumes that it is the DB entity 500 which performs the method of FIG. 3A, it may also be some other network entity or the MD 400 itself, which performs the method of FIG. 3A. In an embodiment, the DB entity 500 is in the MD 400.

Further, in step 302, the DB entity 500 acquires (e.g. receives) motion data 324 of the MD 400 measured by at least one inertial measurement unit (IMU) comprised in the mobile device 400. The IMU may comprise at least one acceleration sensor. The acceleration sensor may be capable of detecting the gravitational force G. The IMU may optionally also comprise other inertial sensors, such as at least one gyroscope, for detecting angular velocities about the vertical Z axis, for example. There may also be an odometer present in the MD 400 for detecting information related to the movement of the person 210 carrying the PD 400. The motion data 324 may represent the motion of the MD 400 in the 3D coordinate system (X′, Y′, Z′) of the MD 400, which may be different from the 3D coordinate system (X, Y, Z) of the person 210.

In an embodiment, the 3D coordinate system (X, Y, Z) of the person 210 carrying the mobile device 400 comprises a first horizontal axis (X) along the movement direction 212 of the person 210, a second horizontal axis (Y) having a right angle with the first horizontal axis (X), and a vertical axis (Z). In an embodiment, the 3D coordinate system (X′, Y′, Z′) of the MD 400 comprises a first horizontal axis (X′) along one dimension of the mobile device 400, a second horizontal axis (Y′) having a right angle with the first horizontal axis (X′), and a vertical axis (Z′). These axes (X′, Y′, Z′) may be different from the corresponding axes (X, Y, Z).

In step 304, the database entity 500 may extract at least one feature from the acquired motion data 324, wherein at least one feature is related to at least one dominant movement direction of the mobile device 400 in a 3D coordinate system (X′, Y′, Z′) of the mobile device 400. The feature may also be called an explanatory variable. Let us take a look at the possible extracted features later.

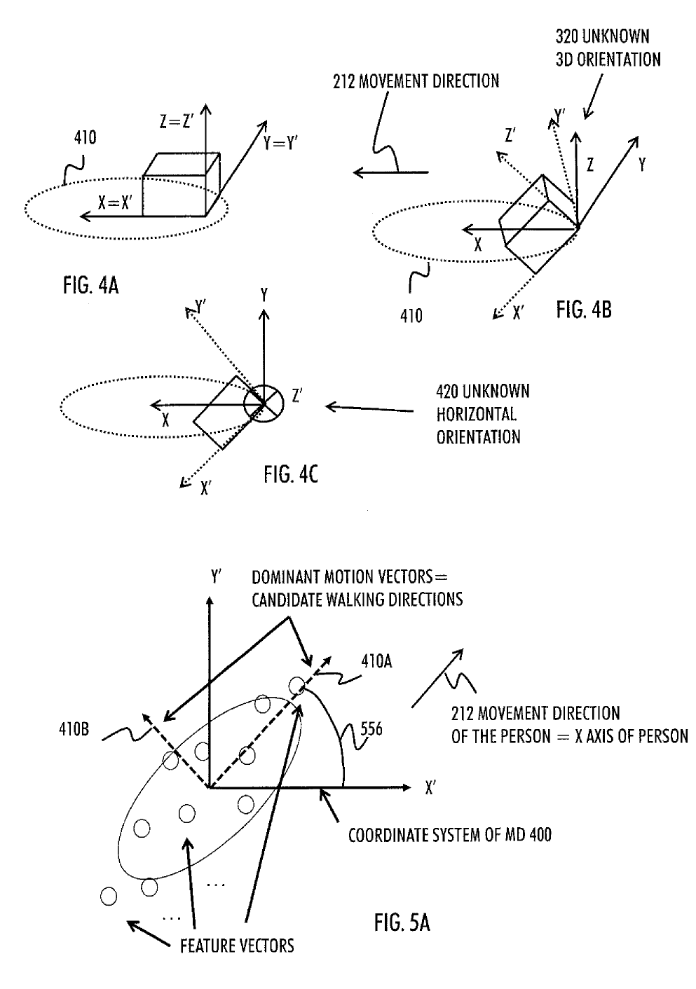

Let us now look at the dominant movement direction closer with respect to FIG. 4. In FIGS. 4A-4C, the dotted ellipse 410 corresponds to the at least one dominant movement/motion direction on the basis of the acquired motion data 324. It should be noted that rarely the direction of movement is exclusively in one direction. For example, the walking of the person 210 may cause the direction of the movement to vary slightly around the intended movement direction 212. This is why the ellipse 410 is used to depict the at least one dominant movement direction. In case the 3D orientation of the MD 400 is according to the 3D coordinate axes (X, Y, Z) of the person 210 (e.g. is not rotated about the axes (X, Y, Z)), as shown in FIG. 4A, the determined dominant movement direction(s) 410 comprise the X′-axis of the MD's 400 coordinate system (X′, Y′, Z′). However, as shown in FIG. 4B, in case the 3D orientation of the MD 400 does not match with the 3D coordinate axes (X, Y, Z) of the person 210 (e.g. is rotated about the axes (X, Y, Z)), the determined dominant movement direction(s) 410 do not comprise the X′-axis of the MD's 400 coordinate system (X′, Y′, Z′).

In order to simplify the 3D orientation correction, in an embodiment, the DB entity 500 may be able to determine the amount of rotation of the mobile device 400 about the horizontal axes (X, Y) of the 3D coordinate system of the person 210 on the basis of the acquired motion data 324 and the known direction of gravity G caused by the Earth's gravitation. Thereafter, the DB 500 may align the 3D orientation of the mobile device 400 with a 2D plane defined by the horizontal axes (X, Y) of the 3D coordinate system of the person 210. Further, the DB entity 500 may adjust the acquired EMF measurement result data and the acquired motion data on the basis of the determined amount of rotations about the horizontal axes. Thus, the acquired data may now advantageously be presented in 2D (i.e. in the floor plane). FIG. 4C shows this aligned orientation of the MD 400 in the 2D plane defined by the X and Y axis. By performing this embodiment, the determination of the 3D orientation of the MD 400 in the 3D coordinate system of the person 210 may be simplified as only the rotation about the Z axis (a rotated Z′ axis is towards the paper, as shown with a cross inside a circle) needs to be determined anymore. In other words, instead of having an unknown 3D orientation 320, the MD 400 is only in an unknown horizontal orientation 420. However, although the rotation about the X and Y axis may in general be correctable with the help of the global reference (e.g. the gravitational force G), the rotation about the vertical Z-axis may not be corrected as easily due to lack of any known global reference. For example, the compass direction may not be towards north indoors. However, as will be explained, the extracted at least one feature from the acquired motion data 324 of the MD 400 may help in this problem. It should be noted that the simplification of FIG. 4C is neither required nor necessary—the orientation correction may be performed equally in the 3D coordinate system. However, the simplification of FIG. 4C may ease the complexity.

In step 306, the DB entity 500 determines at least one angle estimate of a difference between the 3D orientation of the mobile device 400 and the at least one dominant movement direction on the basis of the at least one extracted feature. It should be noted that the at least one dominant movement direction of the MD 400 most likely comprises the movement direction 212 of the person 210. In step 308, the DB entity 500 adjusts the acquired EMF measurement results on the basis of the determined at least one angle estimate. It should be noted that in case the rotations about the X and Y axis have been corrected earlier (by utilizing the known direction of the gravitational force G, as said in FIG. 4C), then in step 306 the at least one angle estimate may represent the difference between the horizontal orientation of the mobile device 400 and the movement direction 212 of the person 210. The at least one angle estimate may be used to detect the 3D orientation of the MD 400, in which orientation the acquired EMF measurement results 322 have been measured. Thus, the DB entity 500 may adjust the acquired EMF measurement results on the basis of the angle estimate to the known coordinate system so that also orientation variant data may be used for tracking/positioning.

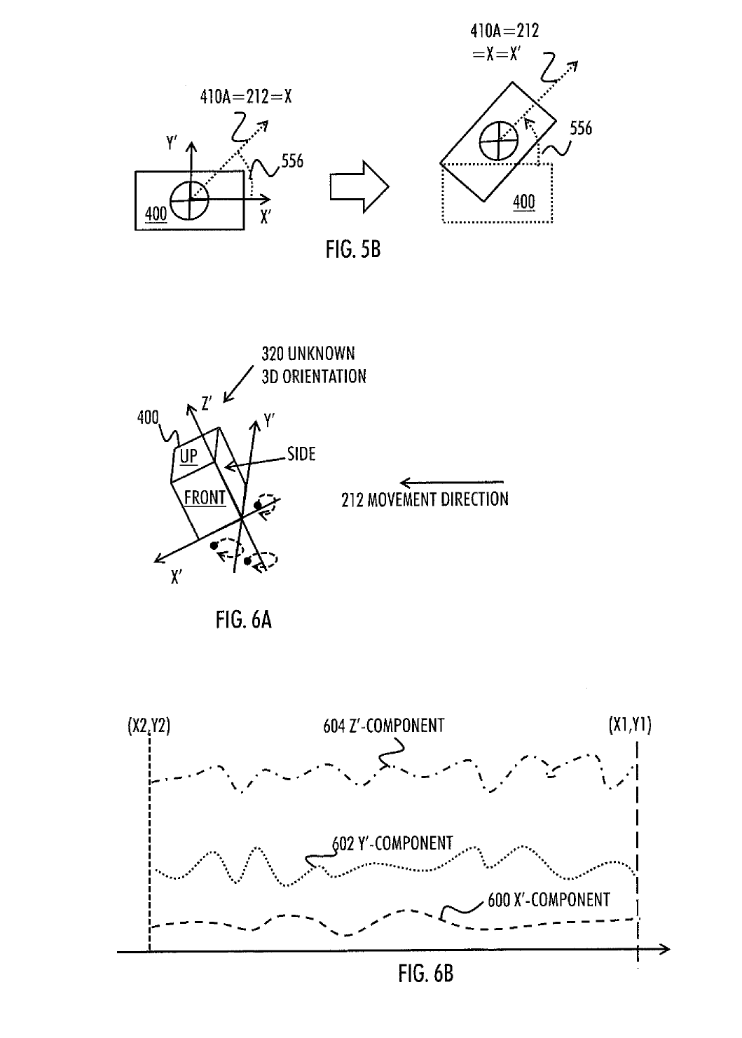

In an embodiment, the at least one feature is extracted continuously or repeatedly from the motion data 324. Each instantaneous feature may be plotted/projected in a 3- or a 2-dimensional coordinate system as feature vectors. Thus, the extracted features may be multidimensional. This is shown in FIG. 5A with respect to projection to 2D coordinate system of the MD 400. The at least one feature (vector), marked with the circles in FIG. 5A, may be acquired from the raw motion data 324 or they may be derived from the motion data 324. In an embodiment, the feature extracted from the motion data 324 may be a derived parameter or abstraction of the acquired motion data 324. The extracted features may represent, e.g., time and/or frequency components computed from the motion data 324. In an embodiment, the feature(s) may represent a moving variance between consecutive motion data values. In an embodiment, the feature(s) may represent dominant frequency component(s) and/or phase component(s) of the motion data 324. In order to acquire the frequency components, there may be a spectrum analysis or a 2D/3D Fourier transform performed for the motion data 324. In an embodiment, the feature extracted from the motion data 324 may be a time series of raw motion data 324 with respect to at least one motion component. In an embodiment, the extracted features represent the dominant motion direction of the MD 400 in a three-dimensional coordinate system of the MD 400. These features provide thus also an indication of the moving direction 212 of the person 210.

The features which most efficiently reveal the orientation difference between the orientation of the person 210 and the orientation of the MD 400 may be learned on the basis of empirical analysis or mathematical modeling. The features may be selected such that a rotation of the MD 400 rotates proportionally also the distribution of the extracted features in at least one subspace and the dominant motion component of the acquired motion data 324. In an embodiment, distribution of the feature values extracted from the motion data 324 may be determined. Each distribution of the feature values may be a function of the rotation about the vertical axis (in case the 2D simplification of FIG. 4C is performed) or a function of the 3D orientation difference (in case the 2D simplification of FIG. 4C is not performed). As a result, e.g. it may be checked which 2D rotation or 3D orientation of the MD 400 explains the currently determined distribution.

In an embodiment, different motion components of the acquired motion data 324 may be obtained on the basis of a subspace analysis performed to the acquired motion data 324. The subspace analysis may be also called a dimensionality reduction or projection method. The (stationary) subspace analysis may comprise, for example, independent component analysis (ICA), principal component analysis (PCA), factor analysis, to mention only a few methods known by a skilled person to extract different components from a signal. The subspace analysis may be thus seen as a blind source separation algorithm which factorizes a multivariate series into stationary and non-stationary components.

In an embodiment, the motion component, which corresponds to the movement direction 212, may be characterized with certain acceleration signal waveforms or patterns, which may be analyzed in time and/or frequency domains, for example. Such motion data component may show characteristic periodic acceleration patterns generated by the walking gait of a person. This is because typically while a person walks, the accelerations in the walking direction, and accelerations in the directions orthogonal to the walking direction produce distinct periodic acceleration patterns, for example because the person 210 may lean to both sides while walking towards the dominant movement direction. Also, in case the Z-component is analyzed, the Z-component may show strides being taken periodically.

Let us consider the case shown in FIGS. 5A and 5B, which show an unsupervised method for the orientation determination. The method may be called unsupervised as it does not rely on prior knowledge of any training data with known target variables or labels (e.g., reference orientation) of the MD 400 but the 3D orientation determination may be made solely on the basis of the acquired motion data 324 from the MD 400. Further, for simplicity reasons, it is assumed that the rotations about the X and Y axis have been corrected so that the orientation of the MD 400 is in the 2D horizontal plane of the person 210 and the rotated Z′ axis is towards the paper (as shown with a cross inside a circle). Likewise, the acquired EMF measurement results 322 and the acquired motion data 324 may in this case be observed in the 2D floor plane. However, this need not be the case and the orientation correction may be performed directly from the 3D orientation. It may be appreciated though that determining the rotations about the X and Y axis first on the basis of the known direction of gravity G and the acquired motion data 324 of the MD 400 may ease the complexity of determining the rotation about the Z axis.

FIG. 5A shows two dominant motion directions 410A, 410B, which correspond to two candidate walking directions (e.g. eigenvectors), which may have been detected by performing the subspace analysis, such as the PCA or the ICA, for example, on the feature (vectors) data extracted from the motion data 324. Further, it may be considered that the candidate walking direction 410A comprises the movement direction 212 of the person 210. It may be that the eigenvalue in the direction 410A is, for example, larger than the eigenvalue in direction 410B, which may indicate that the direction of movement 212 corresponds to the direction of 410A. Further, if the horizontal orientation of the MD 400 is not aligned with the X and Y axis of the coordinate system of the person 210, the dominant motion direction 410A of the motion data 324 may not correspond to the X′ direction.

Now, it may be detected that the dominant motion direction 410A (which indicates the walking direction 212 of the person 210) deviates from the X′ direction by an angle 556, as shown in FIG. 5A. This angle estimate 556 may be taken as the estimated orientation difference between orientation of the person 210 and the orientation of the MD 400. As the dominant motion direction 410A may be detected on the basis of the features and the X′ direction is known, the angle estimate 556 may be obtained.

In case the detected motion vectors (e.g. eigenvectors) are equally dominant in directions 410A, 410B (and possibly also in some other directions), then two (or more) angle estimates may be determined, out of which one is likely to be the correct one.

This correct angle estimate of the two (or more) angle estimates may become apparent later, for example, during performing the EMF based location/tracking of the person 210. Thus, in such case, the possible amount of hypothesis for the orientation difference is significantly reduced which makes the process more efficient.

As a result, as shown in FIG. 5B, the angle estimate 556 may be used to theoretically adjust the orientation of the MD 400 so that the first horizontal axis (X′) of the coordinate system (X′, Y′, Z′) of the MD 400 becomes parallel with the moving direction 212 (i.e. with the X axis of the coordinate system of the person 210). Further, the acquired EMF measurement data (such as the direction of the measured EMF vector) may be orientation-corrected to a known orientation in the coordinate system of the person 210, and used in positioning and/or tracking of the MD 400.

In an embodiment, it should be noted that the output of the angle estimation may comprise more than one angle 556 as there may be many dominant movement directions 410, such as 410A, 410B of FIG. 5A. In such case, it may be that the DB entity 500 provides several angle estimates. In an embodiment, the angle estimates may be used for generating a distribution of an angle difference between the orientation of the MD 400 and the moving direction 212 of the person 210. Such plurality of angle estimates or the distribution thereof may be recorded and used to imply uncertainty of the rotation correction.

In an embodiment, the at least one feature of the acquired motion data 324 represents a case in which the person carrying the MD 400 at hand swings his/her arms while walking. There may be a predefined feature type computed from the motion data 324 which reflects such action of the person 210. In such case, the dominant motion direction 410 may be detected on the basis of the computed feature and used for determining the angle estimate 556.

Let us now look at another embodiment in which reference motion data or a learning/training data set is applied for obtaining the at least one angle estimate. Thus, this embodiment may be seen as a supervised or at least semi-supervised method of orientation determination. Let us look at this embodiment with reference to FIGS. 6, 7 and 8 by first assuming with respect to FIGS. 6A and 6B that the MD 400 is in the unknown 3D orientation 320. Thus, the axes X′, Y′ and Z′ are rotated about the 3D coordinate system (X, Y, Z) of the person 210, wherein the X-axis is parallel with the movement direction 212 of the person 210. The MD 400 measures and transmits motion data 324 to the database server 500 while being in this unknown 3D orientation 320. Let us further assume that the different directional components X′, Y′ and Z′ of the received motion data 324 have the following signal waveforms 600, 602, 604, as shown in FIG. 6B. Naturally, as known by the skilled person, these signal waveforms 600, 602, 604 may be represented in vectors (e.g., multiple descriptive features of motion data 324) or matrices (e.g. multivariate time-series of motion data 324), for example. Alternatively, an abstraction or a derivable of the signal waveforms may be obtained in any means known to a skilled person.

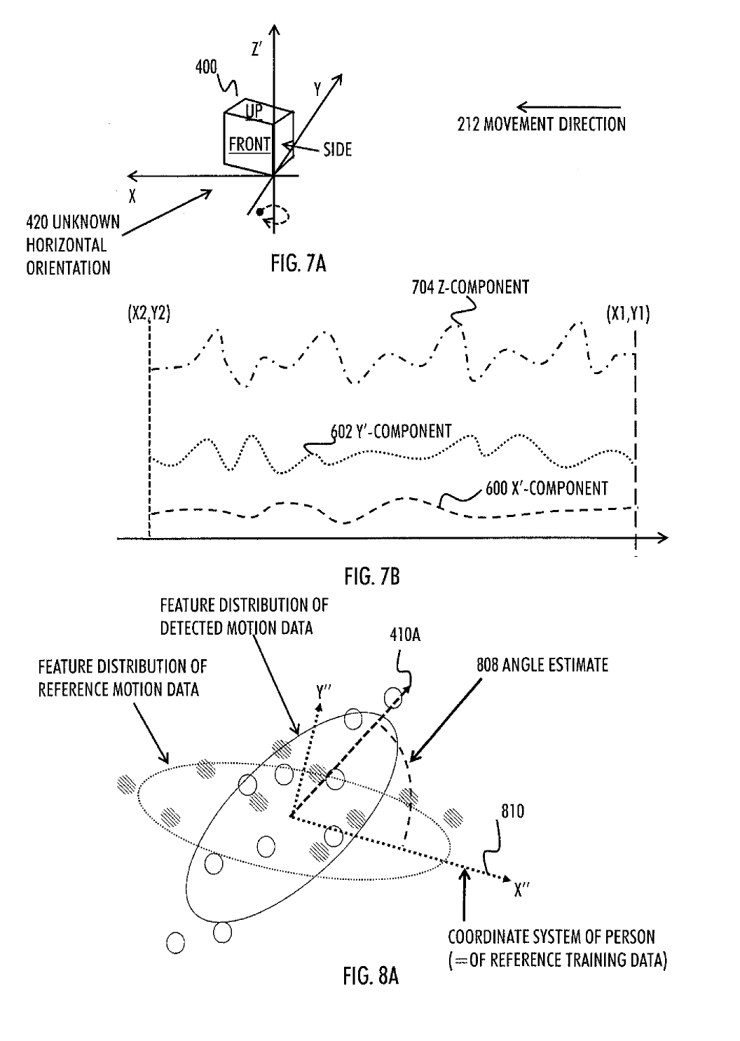

As explained earlier with respect to FIG. 4C, the unknown 3D orientation 320 of the MD 400 may, in an embodiment, be simplified to unknown horizontal orientation 420. As a result, FIG. 7A shows the MD 400 being in the unknown horizontal orientation 420, instead of being in the unknown 3D orientation 320. As shown, the MD 400 is rotated only about the Z axis (shown with rotated Z′). Further, it is now possible to adjust the Z′ signal waveform 604 by applying the knowledge of the rotations about the horizontal X and Y axis. For example, if it is determined that the MD 400 is rotated 20 degrees about the X-axis and 10 degrees about the Y-axis, the DB entity 500 may check what is the motion data component in a direction which corresponds to those rotations in the 3D space, and consider that as a Z-component 704. FIG. 7B shows the corrected signal waveform 704. As shown, the Z-component 704 shows a somewhat clear pattern which may have been caused by the steps taken by the walking/running person 210. However, as the rotation about the Z-axis is not correctable by applying the direction of gravity G, the components X′ and Y′ remain uncorrected in FIG. 7B.

However, as said, the DB entity 500 may acquire (e.g. receive) reference motion data corresponding to at least one reference 3D orientation in the frame of reference of the person 210. The reference 3D orientation may correspond to any orientation. However, in an embodiment the at least one reference 3D orientation (or coordinate system) corresponds to an orientation (or coordinate system) in which the first horizontal axis (X′) of the 3D coordinate system of the MD 400 is parallel with the movement direction 212 of the person 210. That is, to an orientation in which the MD 400 is oriented towards the movement direction 212. In this orientation, the coordinate system (X, Y, Z) of the person 210 corresponds to the coordinate system (X′, Y′, Z′) of the MD 400.

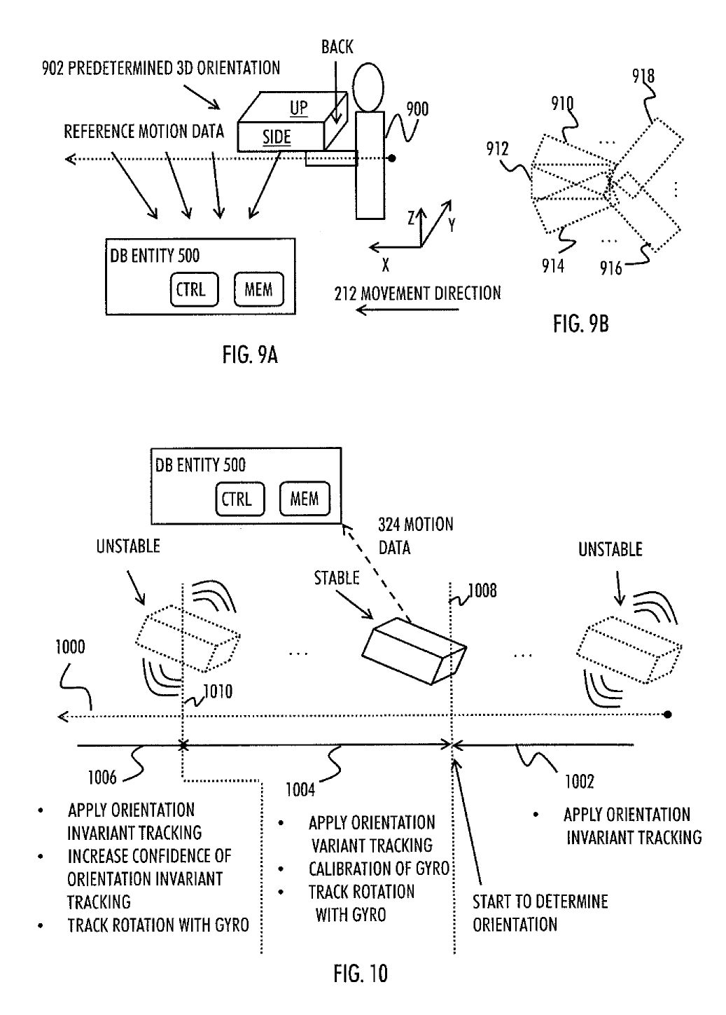

FIG. 9A shows an embodiment for acquiring the reference motion data. In this embodiment, a person 900 keeps a mobile device in the reference 3D orientation 902 during measurements. In an embodiment, there may be many reference orientations. However, for each reference orientation, the mobile device is accurately kept in the correct, desired orientation. For each orientation, EMF and motion data are measured, transmitted with the known orientation information to the DB entity 500 and stored. The stored motion data with respect to many orientations serves as the reference motion data. The reference motion data may be measured by the MD 400 or some other device, such as a mapping device carried by a mapper and contributing to the generation of the EMF map for the building 100.

Although it is possible that there are many reference orientations, for the sake of simplicity, let us assume that there is only one reference orientation 902, and motion data referring to this orientation 902 is used as the reference motion data. It should also be noted that in case the rotations about the X and Y axis have been corrected earlier, then the predetermined 3D orientation may be simplified to a predetermined horizontal orientation. However, as understood by a skilled person, this is not necessary and the orientation correction may be performed three-dimensionally.

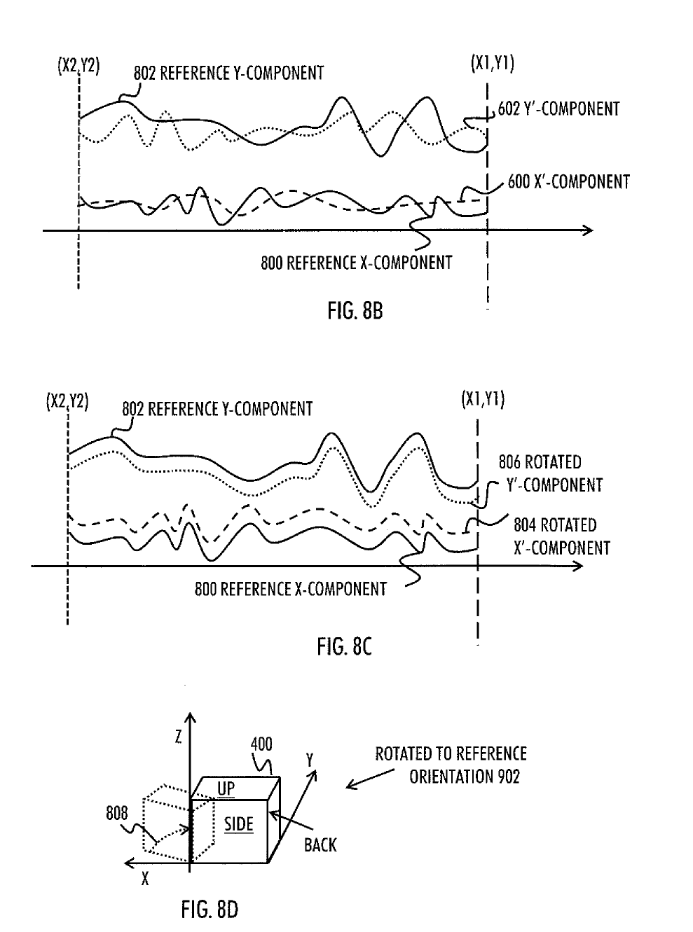

Let us consider here a case (similar to as depicted in FIG. 5A) in which the at least one feature (vector) extracted from the motion data 324 is plotted in the 2D coordinate system. In an embodiment, further to this, the same feature may be extracted from the reference motion data, and the features, or distributions of feature values, may be compare and projected/plotted on the same coordinate system or subspace. Thus, distributions of these features are obtained, as shown in FIG. 8A. in which a solid ellipse represents the distribution of feature values/vectors (marked with empty circles) acquired from the received motion data 324 and a dotted ellipse represents the distribution of feature values/vectors (marked with circles having left leaning diagonal lines) acquired from the training/reference data.

However, on the contrary to the case of FIG. 5A, the reference data may be used for the correction orientation. Further, the reference coordinate system (X″, Y″) of the reference motion data is known and may, in an embodiment, correspond to the coordinate system (X, Y) of the person 210 (therefore, X″ may be parallel to the movement direction 212). As a result, an angle estimate 808 may be determined as the difference between the dominant motion direction 410A of the extracted motion data 324 and the dominant direction 810 of the reference motion data. There may be, for example, a database of explanatory angle estimates which explain the difference between the at least one feature of the reference motion data and the same at least one feature determined from the acquired motion data 324.

Let us now take a look at another embodiment of determining the angle difference 808 with the help of reference motion data by referring to FIGS. 8B to 8C. An example of X and Y components extracted from the reference motion data is given in FIG. 8B with the solid waveforms 800 and 802. In the same Figure the orientation-uncorrected X′ and Y′ components 600, 602 are shown. It may be seen that the corresponding components do not match with each other. From this it may be detected that the current orientation of the MD 400 is not the same as the reference orientation 902. It may be assumed that in the reference orientation 902, the X-axis of the device of FIG. 9 may be parallel with the moving direction 212. Thus, the current orientation of the MD 400 may be rotated with respect to the moving direction 212.

As the component(s) of FIG. 8B do not match, the DB entity 500 may need to extract the at least one feature from the acquired motion data 324. In this embodiment, the at least one feature extracted from the motion data 324 may comprise a motion data component corresponding to at least one direction in the 3D coordinate system of the mobile device 400. However, let us here consider that the at least one feature represents the motion data components in the directions of the orthogonal horizontal axes (X′ and Y′) of the 3D coordinate system of the mobile device 400. That is, the at least one feature may represent the X′ and Y′ waveforms 600 and 602. This type of extracted feature is also related to the dominant movement direction 410 of the MD 400 (e.g. the movement direction 212) because if the dominant movement direction 410 were to change, the measured motion of the mobile device 400 with respect to orthogonal horizontal axes (X′ and Y′) would change as well. Each of these waveforms of FIGS. 8B and 8C may be represented with a vector, a derivable, abstraction or any statistical variable characterizing the waveforms. The feature(s) may be determined in frequency domain and/or in time domain.

Thereafter, the DB entity 500 may apply the extracted at least one feature (e.g. X′ and Y′ components 600, 602) of the acquired motion data 324 and the reference motion data (X and Y components 800, 802) for determining the at least one angle estimate, such as the angle estimate 808 of FIG. 8D, wherein the amount of rotation indicated by the at least one angle estimate is with respect to the reference 3D orientation. In case the rotation about the X and Y axes have been corrected already, then the angle estimate represents an estimated amount of rotation of the MD 400 about the vertical axis (Z) of the 3D coordinate system of the person 210.

Then, the DB entity 500 may apply the reference motion data (X and Y waveforms 800, 802) to estimate which orientation of the mobile device 400 explains the behavior or value of the extracted at least one feature (X′ and Y′ waveforms 600, 602). As such, the reference motion data may be considered to indicate what the at least one feature (X′, Y′ waveforms) of the acquired motion data 324 should be when the MD 400 is in the reference (3D or horizontal) orientation 902. For example, the DB entity 500 may calculate different motion data components corresponding to different directions in the coordinate system of the MD 400. The Z-direction is omitted here as the rotations about the X and Y axes are assumed to be corrected already by applying the known direction of gravity G.

From the calculated components (or statistical variables thereof) it may be detected, as shown in FIG. 8C, which rotated X′ and Y′ components 804 and 806 match with the reference X and Y components 800, 802, respectively. Basically this corresponds to detecting how much the MD 400 needs to be rotated in order to obtain components 804 and 806 which match with the reference motion data components 800, 802. For example, it may be detected that a rotated X′ component 804 corresponding to an angle 808 of 70 degrees, for example, matches with the reference X-component 800. The detection of the match rate may be performed by determining, e.g. phase differences of the at least one feature and the reference motion data. There may be a predefined similarity threshold which needs to be met before the match is considered sufficient. As a result, it may be considered that the component of the acquired motion data 324 corresponding to the direction X′+70 degrees is the same or at least close to the same as the movement direction 212 (i.e. parallel with the X axis of the coordinate system of the person 210). Similarly, a good match with the rotated Y′ component corresponding to the direction Y′+70 and the reference Y-component 802 may be observed.

It should be noted that the Figures are not in proportion in the vertical direction. For example, the components 802 and 806 may overlap completely. However in some cases the reference motion data is obtained from a different mobile device. In this case, there may be some bias between the two devices and, thus, a complete overlap is not detected but a similar behavior of the waveforms 802 and 806, for example.

As a result, the database entity 500 may determine the angle estimate on the basis of the angle difference between the at least one reference (2D or 3D) orientation 902 and the estimated (2D or 3D) orientation of the MD 400. Then, the acquired EMF measurement results, such as the direction related EMF results, may be adjusted to a known orientation on the basis of the angle estimate 808 and used for positioning/tracking. As one example, the acquired EMF data components of FIG. 2B may be adjusted to correspond to the reference orientation now that the angle estimate(s) 808 is known. As said earlier, it may be important that the EMF results are adjusted to correspond to the reference orientation 902, because the values of the EMF map may also correspond to the reference orientation 902. Without the adjustment of the acquired EMF values, the orientation variant EMF data would not be usable. It should be noted that in case the determined 3D orientation of the MD 400 correspond to the (X, Y, Z) coordinate system of the person 210, then no adjustment is needed (or an adjustment of zero) to the acquired EMF values.

As such, the database entity 500 may determine the 3D orientation of the mobile device 400 in the 3D coordinate system of the person 210 on the basis of the determined amount of rotations about the horizontal (X, Y) and vertical (Z) axes. Thus, the unknown orientation of the MD 400 shown in FIG. 6A becomes known, as shown in FIG. 8D. Further, the DB entity 500 may estimate the movement direction 212 of the person 210 carrying the mobile device 400 on the basis of the acquired motion data 324, and more particularly, on the basis of the determined dominant movement direction 410 of the MD 400 or by comparing the at least on feature computed from the reference motion data with the at least one feature computed from acquired motion data 324. The proposed solution may be especially useful in situations where the MD 400 is kept in a pocket, in a bag, or in any location in which the MD 400 stays relatively stable so that the orientation correction may be performed reliably.

As said, in an embodiment, the reference motion data represents many reference orientations 910 to 918, as shown in FIG. 9B. Then, the DB entity 500 may, for example, compare the extracted feature, such as the X′ and Y′ motion components to the plurality X and Y components of the reference motion data, each X and Y components associated with a certain reference orientation 910 to 918. When the DB entity 500 detects that the X′ and Y′ motion components match with the X and Y components associated with a certain reference orientation, e.g. the reference orientation 914, the DB entity 500 may decide that the MD 400 is currently in the certain reference orientation 914. Then the DB entity 500 may determine the angle estimate 808 on the basis of the rotation between the certain reference orientation 914 and the movement direction 212 of the person 210. As a consequence, the DB entity 500 may correct the acquired EMF values on the basis of the angle estimate 808. The correction may comprise adjusting the acquired magnetic field vector measurement results from the frame of reference of the MD 400 to the frame of reference (i.e. to the coordinate system) of the person 210. This type of orientation correction may be called a supervised approach due to the knowledge of the reference motion data representing several 3D orientations 910 to 918.

In an embodiment, the reference motion data represents a case in which the person carrying the MD 400 swings his/her arms while walking. If the determined at least one feature from the acquired motion data 324 corresponds to such reference motion data, then the 3D orientation of the MD 400 may be determined on the basis of the such reference motion data.

Although it may be that the proposed method of FIG. 3A results in one, correct angle estimate, it may also be that the method results in more than one angle estimate. This may be the case if there are many motion data components 554 corresponding to the dominant movement direction 410 of the MD 400, or if the comparison between the reference motion data and the acquired motion data 324 provides several possible angle estimates. In an embodiment, in case there are many equally probable angle estimates, the MD 400 may decide to apply some orientation invariant location estimation and/or tracking in order to increase reliability. There may be a threshold for changing into applying the orientation invariant location estimation and/or tracking instead of orientation variant location estimation and/or tracking.

Nevertheless, even such information of several angle estimates may help the process of determining the correct 3D orientation of the MD 400. For example, this information may be used to reduce the search space for the one correct orientation of the MD 400. A further search for the correct 3D orientation may be performed, for example, by applying the knowledge of the direction of the true magnetic field vector at the location where the MD 400 is assumed to be located (i.e. at the location hypothesis of the MD 400). The direction of the true magnetic field vector for the at least one position hypothesis of the MD 400 may be known on the basis of a predetermined EMF map at the at least one location corresponding to the at least one position hypothesis of the MD 400. For further description about the correction of the three dimensional orientation of the MD 400 on the basis of the EMF map may be found from U.S. patent application Ser. No. 13/739,640, the content of which is incorporated herein by reference.

Let us next look some embodiment with respect to FIG. 10. Let us assume that while the person 210 is moving in the building along a path 1000 from right to left, the person 210 is for example swinging his/her arms holding the MD 400 during a time period 1002, thus causing the MD 400 to be unstable. During a time period 1004, the MD 400 is stable. It may be for example that the person 210 has put the MD 400 in his pocket, initiated/received a phone call with the MD 400 or stopped swinging his/her arms. Thereafter, during time period 1006, the MD 400 becomes unstable again with respect to the movement of the MD 400. The DB entity 500 may detect such stability/instability from the acquired motion data 324. For example, the motion data 324 may imply large irregular movements which may be due to the person 210 keeping the MD 400 in his/her swinging arms. Further, for example, data from a gyroscope may reveal whether the rotation of the MD 400 is changing or not. On the other hand, the motion data 324 may show steady and/or small movement, or no motion at all.

In an embodiment, the DB entity 500 may detect, on the basis of the acquired motion data 324, when the three-dimensional orientation of the mobile device fulfills a predetermined criterion with respect to stability. The predetermined criterion with respect to stability may be empirically derived or based on mathematical modeling. The criterion may be set so that the MD 400 fulfilling the criterion is considered stable enough in order to start determining the current 3D orientation of the MD 400. The criterion may be specified at least partly in time domain so that if the MD 400 has been stable for a predetermined amount of time, it may be worthwhile to start determining the current 3D orientation of the MD 400. On the other hand, the criterion may be specified at least partly in spatial domain so that if the MD 400 shows only small or regular rotations, such as less than a few degrees, then it may be worthwhile to start determining the current 3D orientation of the MD 400.

In an embodiment, even if the MD 400 moves, the gyroscope may be used to detect the movements of the MD 400, at least if it is considered that the gyroscope is accurate at that point (e.g. the drift of the gyroscope is not severe). Then the inertial and/or EMF measurement results may be orientation adjusted on the basis of the gyroscope detections.

Upon detecting that the predetermined criterion with respect to stability is met, the DB entity 500 may start to determine the 3D orientation of the MD 400, such as the amount of rotation about vertical axis. Looking at FIG. 10, it may be seen that the motion data 324 indicates stability fulfilling the criterion from point 1008 (at the start of time period 1004) onwards. From this point 1008 onwards, the DB entity 500 may start to apply the acquired motion data 324 for the orientation determination. The DB entity 500 may apply only motion data 324 acquired while the 3D orientation of the mobile device 400 fulfills the predetermined criterion with respect to stability. Thus, only motion data 324 obtained during period 1004 may be used for the orientation correction. As the DB 500 may be able to estimate the orientation of the MD 400 during time period 1004, the DB entity 500 may advantageously apply orientation variant location estimation and/or tracking for the MD 400. Such orientation variant location estimation and/or tracking may apply the direction of the EMF vector, for example.

However, during periods 1002 and 1006, while the MD 400 is unstable, the DB entity 500 may avoid applying any orientation variant EMF based location estimation and/or tracking. This is because if the orientation of the MD 400 is unstable (e.g. the three-dimensional orientation of the mobile device does not fulfill the predetermined criterion with respect to stability), the reliability of any orientation variant location estimation/tracking may not be sufficient. Such instability or not fulfilling the predetermined criterion with respect to stability may refer to a case where the motion of the MD 400 cannot be detected with the gyroscope or other inertial sensors reliably. As a result, the DB entity 500 may instead decide to apply orientation invariant location estimation and/or tracking during the time periods 1002, 1006. These orientation invariant location estimation techniques may comprise at least one the following: non-EMF based location estimation and/or tracking, an orientation invariant EMF based location estimation and/or tracking. The non-EMF based location estimation and/or tracking may comprise, e.g., a radio frequency (RF) based tracking (applying WiFi or wireless local area network (WLAN) access points and signal strength measurements, for example), air pressure based tracking, machine vision based tracking, to mention only a few non-limiting examples. The orientation invariant EMF based location estimation and/or tracking may comprise detecting the location of the MD 400 on the basis of EMF magnitude, not the direction, for example. Further, in case the orientation of the MD 400 may be projected in the 2D plane, as explained with reference to FIG. 4C, it may still be possible and advantageous to determine the magnitude of the XY-plane projection and the magnitude of the Z-component. Namely, the norm of the XY-plane projection ∥m∥xy of the EMF vector m=(x,y,z) may be determined as ∥m∥xy=sqrt(x2+y2) even without adjusting the rotation about the Z-axis. As a result, the feature vector (z, ∥m∥xy) may be computed from the tilt compensated magnetic field observation, which feature vector is invariant to the rotation about the Z-axis. These two features enable for more EMF vector information than the magnitude alone, because the magnitude may be represented separately for the Z-axis component and for the XY-plane projection.

After the stability of the MD 400 is detected not to be sufficiently good in point 1010, the DB 500 may again start applying any orientation invariant location tracking/estimation. However, the DB entity 500 may continue performing also location orientation variant location tracking/estimation. Nevertheless, in an embodiment, as shown under the period 1006, the DB entity 500 may decide to increase a confidence of the applied orientation invariant location estimation and/or tracking approach during the time period when the 3D orientation of the MD 400 does not fulfill the predetermined criterion with respect to stability. As a consequence, the location estimates provided by the orientation variant and orientation invariant techniques may be differently weighed. For example, if the RF based location estimation indicates a first location and the orientation variant (e.g. EMF direction based) location estimation indicates a second location, the DB entity 500 may give more weight to the first location and estimate that the person 210 is in the first location. This may be advantageous as then the true location of the MD 400 (and of the person 210) may be more reliably detected.

As the 3D orientation is known during period 1004, which naturally comprises also knowing the horizontal orientation of the MD 400 in the 3D coordinate system of the person 210, the DB entity 500 may, in an embodiment, apply the estimated horizontal orientation of the mobile device 400 in calibrating or resetting a gyroscope comprised in the mobile device 400. As known by a skilled person, the gyroscope may not be able to follow the absolute rotation in the coordinate system. This may be because the gyroscope may be accurate for some time after calibration but rather quickly may start to drift from the correct orientation due to gyroscope sensor inaccuracies such as sensor noise and bias. Thus, the calibration of the gyroscope may be important, e.g. in order to provide a gyroscope based orientation estimate. Typically the gyroscope may be calibrated in specific locations reserved for calibration. This may be too rarely as the accuracy of the gyroscope may have drifted between those locations. However, the proposed embodiment may allow the calibration to take place as often as needed and on-the-fly without any need for proximity of a specific calibration location. As a result, the DB entity 500 may apply information measured by the gyroscope in tracking the movement of the person 210 carrying the mobile device 400. For example, the gyroscope may be used to detect the rotation about the Z-axis, at least for a short while after the calibration. This tracking by utilizing the gyroscope may take place at least during parts of periods 1004 and 1006, as shown in FIG. 10. This may be beneficial as this may increase the efficiency and accuracy of the location estimation/tracking.

In an embodiment, the stability of the MD 400 is further detected or adjusted on the basis of the gyroscope. For example, small or regular movement of the MD 400 may be correctable during a certain time window by applying the gyroscope. This may advantageously allow a longer time window for extracting features from the motion data 324 without a risk of having features which are related to significantly different orientations of the MD 400.

In an embodiment, there may be a low range communication unit mounted in the building 100 for allowing calibration of the MD 400 to the correct EMF vector values. For example, the exact magnitude of the EMF may be predetermined and stored in the memory of the mounted low range communication unit. Then the MD 400 may apply this information in obtaining knowledge of how much the measured EMF magnitude deviates from the indicated, true EMV magnitude. Based on the information, a correction of the values provided by the magnetometer or calibration of the magnetometer may be in order. The low range communication may apply, for example, RFID, Bluetooth, or NFC technique. Alternatively, or in addition to, the calibration/correction may be for the direction of the EMF vector. Further, the gyroscope of the MD 400 may be calibrated in these calibration locations. It may be that the person 210 is required to place the MD 400 according to a predetermined horizontal orientation at the calibration location. The calibration process may also calibrate/correct data related to the direction and/or strength of the measured acceleration vector representing the direction of the gravitational force G. For this, the true value for G may have been determined for the predetermined location of the mounted low range communication unit.

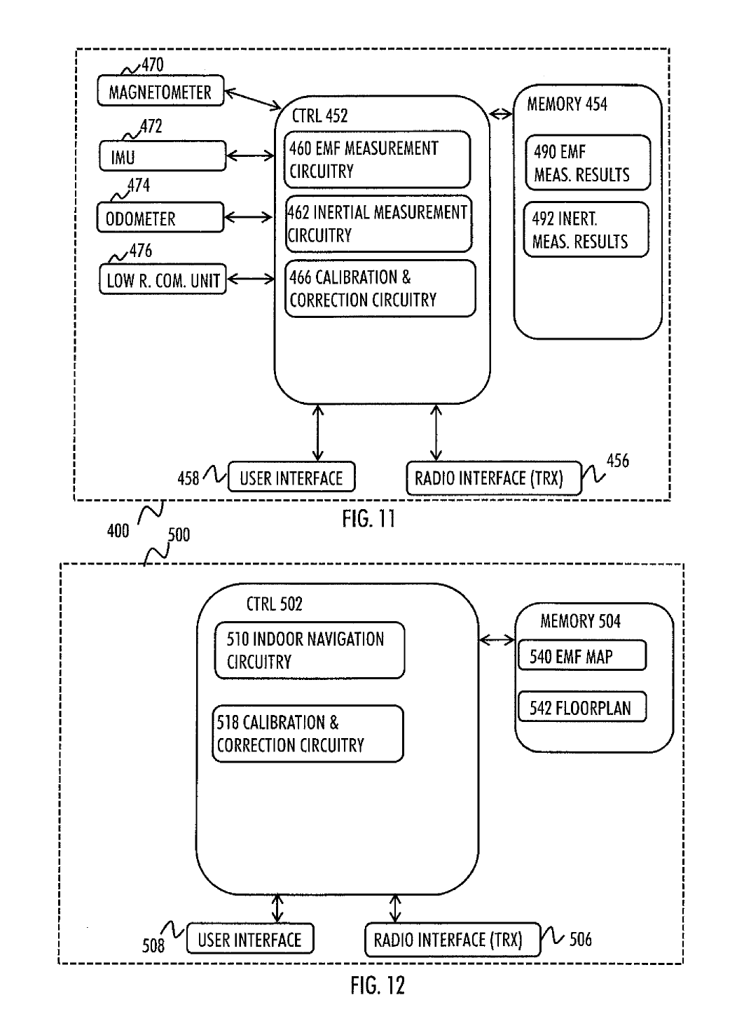

Embodiments, as shown in FIGS. 11 and 12, provide apparatuses 400 and 500 comprising at least one processor 452, 502 and at least one memory 454, 504 including a computer program code, which are configured to cause the apparatuses to carry out functionalities according to the embodiments. The at least one processor 452, 502 may each be implemented with a separate digital signal processor provided with suitable software embedded on a computer readable medium, or with a separate logic circuit, such as an application specific integrated circuit (ASIC).

The apparatuses 400 and 500 may further comprise radio interface components 456 and 506 providing the apparatus 400, 500, respectively, with radio communication capabilities with the radio access network. The radio interfaces 456 and 506 may be used to perform communication capabilities between the apparatuses 400 and 500. The radio interfaces 456 and 506 may be used to communicate data related to the measured EMF vectors, to location estimation, motion data, etc.

User interfaces 458 and 508 may be used in operating the mobile device 400 and the database entity 500 by a user. The user interfaces 458, 508 may each comprise buttons, a keyboard, means for receiving voice commands, such as microphone, touch buttons, slide buttons, etc.

The apparatus 400 may comprise the terminal device of a cellular communication system, e.g. a computer (PC), a laptop, a tabloid computer, a cellular phone, a communicator, a smart phone, a palm computer, or any other communication apparatus. In another embodiment, the apparatus is comprised in such a terminal device, e.g. the apparatus may comprise a circuitry, e.g. a chip, a processor, a micro controller, or a combination of such circuitries in the terminal device and cause the terminal device to carry out the above-described functionalities. Further, the apparatus 400 may be or comprise a module (to be attached to the terminal device) providing connectivity, such as a plug-in unit, an “USB dongle”, or any other kind of unit. The unit may be installed either inside the terminal device or attached to the terminal device with a connector or even wirelessly. In an embodiment, the apparatus 500 as the database entity may locate in the network. In such case, the apparatus 500 may be or be comprised in a server computer. In another embodiment, the apparatus 500 as the database entity may locate within the mobile device 400.

As said, the apparatus 400, such as the mobile phone, may comprise the at least one processor 452. The at least one processor 452 may comprise an EMF measurement circuitry 460 for performing EMF measurements with the help of a magnetometer 470. An inertial measurement circuitry 462 may be for performing motion related measurements with the help of an IMU 472 or an odometer 474, for example. A calibration & correction circuitry 466 may be responsible of performing a calibration process of a magnetometer 470, of the IMU 472, for example.

The magnetometer 470 may be used to measure the EMF vector. There may be various other sensors or functional entities comprised in the PD 400. These may include an inertial measurement unit (IMU) 472, the odometer 474, a low range communication unit 476 for detecting the presence of a proximity communication signal, at least one camera 478, for example. A skilled person understood that these may be of use when performing the embodiments as described earlier. For example, the IMU 472 may comprise for example acceleration sensor and a gyroscope, for example.

The memory 454 may comprise space 490 for storing the EMF measurement results 322 and space 492 for storing the inertial measurement results (e.g. the motion data 324).

The apparatus 500, such as the database entity, may comprise the at least one processor 502. The at least one processor 502 may comprise several circuitries. As an example, an indoor navigation circuitry 510 for performing indoor navigation on the basis of the received set of Earth's magnetic field measurement results. For the navigation, the memory 504 may comprise the EMF map 540, and the floor plan 542 of the building 100. The circuitry 510 may apply for example multi-hypothesis location estimator/tracker/filter, for example. The circuitry 510 may adjust the acquired EMF results on the basis of the determined difference between the 3D orientation of the MD 400 and the moving direction 212. The circuitry 510 may also perform indoor navigation on the basis of orientation invariant methods, such as on the basis of WLAN signal strengths.

A calibration & correction circuitry 518 may be responsible of causing or co-operating in a calibration process of the MD 400 and/or correcting the acquired information from the MD 400, for example. The calibration & correction circuitry 518 may be responsible of making the orientation determination according to any of the embodiments described.

As may be understood by a skilled person from the description of the embodiments throughout the application and from FIGS. 11 and 12, the embodiments may be performed in the MD 400, in the database entity 500, or the execution of embodiments may be shared among the MD 400 and the database entity 500. The skilled person also understands that any required filtering logic may be applied to filter the EMF measurements in order to improve the accuracy. Further, as said, in an embodiment, the database entity 500 co-locates in the MD 400.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in an entity, a cellular network device, or another network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. Coding of software for carrying out the embodiments as shown and described is well within the scope of a person of ordinary skill in the art.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus, comprising:
at least one processor and at least one memory including a computer program code, wherein the at least one memory and the computer program code are configured, with the at least one processor, to cause the apparatus at least to:
acquire Earth's magnetic field, EMF, measurement results indicating the EMF measured by a mobile device in a building, wherein the EMF measurements are performed by the mobile device in an unknown three-dimensional orientation in a three-dimensional coordinate system of a person carrying the mobile device along a movement direction of the person;
acquire motion data of the mobile device, wherein the motion data is measured by at least one inertial measurement unit comprised in the mobile device;
extract at least one feature from the acquired motion data, wherein at least one feature is related to at least one dominant movement direction of the mobile device in a three-dimensional coordinate system of the mobile device, and the at least one dominant movement direction comprises the movement direction of the person;
determine at least one angle estimate of a difference between the three-dimensional orientation of the mobile device and the at least one dominant movement direction on the basis of the at least one feature; and
adjust the acquired EMF measurement results on the basis of the determined at least one angle estimate.

2. The apparatus of claim 1, wherein the three-dimensional coordinate system of the person carrying the mobile device comprises a first horizontal axis along the movement direction of the person, a second horizontal axis having a right angle with the first horizontal axis, and a vertical axis; and
wherein the three-dimensional coordinate system of the mobile device comprises a first horizontal axis along one dimension of the mobile device, a second horizontal axis having a right angle with the first horizontal axis, and a vertical axis.

3. The apparatus of claim 1, wherein the at least one memory and the computer program code are configured, with the at least one processor, to cause the apparatus further to:
determine the amount of rotation of the mobile device about the horizontal axes of the three-dimensional coordinate system of the person on the basis of the acquired motion data and the known direction of gravity; and
align the three-dimensional orientation of the mobile device with a two-dimensional plane defined by the horizontal axes of the three-dimensional coordinate system of the person.

4. The apparatus of claim 1, wherein the at least one memory and the computer program code are configured, with the at least one processor, to cause the apparatus further to:
determine the at least one dominant movement direction of the mobile device in the three-dimensional coordinate system of the mobile device on the basis of the extracted at least one feature.

5. The apparatus of claim 1, wherein the at least one memory and the computer program code are configured, with the at least one processor, to cause the apparatus further to:
acquire reference motion data corresponding to at least one reference three-dimensional orientation of the mobile device in the three-dimensional coordinate system of the person, and
apply the extracted at least one feature and the reference motion data to determine the at least one angle estimate, wherein the reference motion data indicates what the extracted at least one feature should be when the mobile device is in one of the at least one reference three-dimensional orientation

6. The apparatus of claim 5, wherein the at least one memory and the computer program code are configured, with the at least one processor, to cause the apparatus further to:
extract the same at least one feature from the reference motion data;
estimate which three-dimensional orientation of the mobile device explains the difference between the extracted features; and
determine the angle estimate on the basis of an angle difference between the at least one reference three-dimensional orientation and the estimated three-dimensional orientation of the mobile device.

7. The apparatus of claim 6, wherein the at least one memory and the computer program code are configured, with the at least one processor, to cause the apparatus further to:
generate a first a distribution of the extracted at least one feature of the acquired motion data;
generate a second distribution of the extracted at least one feature of the reference motion data; compare the generated distributions in determining the angle estimate.

8. The apparatus of claim 5, wherein the at least one memory and the computer program code are configured, with the at least one processor, to cause the apparatus further to:
determine the reference motion data on the basis of motion related measurement results received from at least one measuring device which is held in one of the at least one reference three-dimensional orientation while performing motion related measurements.

9. The apparatus of claim 5, wherein the at least one reference three-dimensional orientation corresponds to an orientation in which the first horizontal axis of the three-dimensional coordinate system of the mobile device is parallel with the movement direction of the person.

10. The apparatus of claim 1, wherein the at least one memory and the computer program code are configured, with the at least one processor, to cause the apparatus further to:
estimate the horizontal orientation of the mobile device on the basis of the determined at least one angle estimate;
apply the estimated horizontal orientation of the mobile device in calibrating a gyroscope comprised in the mobile device; and
apply information measured by the gyroscope in tracking the movement of the mobile device.

11. The apparatus of claim 1, wherein the at least one memory and the computer program code are configured, with the at least one processor, to cause the apparatus further to:
detect, on the basis of the acquired motion data, when the three-dimensional orientation of the mobile device fulfill a predetermined criterion with respect to stability; and
upon detecting that the predetermined criterion with respect to stability is met, start to determine the three-dimensional orientation of the mobile device, wherein only motion data acquired while the three-dimensional orientation of the mobile device fulfills the predetermined criterion with respect to stability is used for the determination.

12. The apparatus of claim 11, wherein the at least one memory and the computer program code are configured, with the at least one processor, to cause the apparatus further to:
avoid applying an orientation variant EMF based location estimation and/or tracking during a time period when the three-dimensional orientation of the mobile device does not fulfill the predetermined criterion with respect to stability.

13. The apparatus of claim 11, wherein the at least one memory and the computer program code are configured, with the at least one processor, to cause the apparatus further to:
apply orientation invariant location estimation and/or tracking during the time period when the three-dimensional orientation of the mobile device does not fulfill the predetermined criterion with respect to stability.

14. The apparatus of claim 11, wherein the at least one memory and the computer program code are configured, with the at least one processor, to cause the apparatus further to:
increase the confidence of the orientation invariant location estimation and/or tracking during the time period when the three-dimensional orientation of the mobile device does not fulfill the predetermined criterion with respect to stability.

15. A method, comprising:
acquiring Earth's magnetic field, EMF, measurement results indicating the EMF measured by a mobile device in a building, wherein the EMF measurements are performed by the mobile device in an unknown three-dimensional orientation in a three-dimensional coordinate system of a person carrying the mobile device along a movement direction of the person;
acquiring motion data of the mobile device, wherein the motion data is measured by at least one inertial measurement unit comprised in the mobile device;
extracting at least one feature from the acquired motion data, wherein at least one feature is related to at least one dominant movement direction of the mobile device in a three-dimensional coordinate system of the mobile device, and the at least one dominant movement direction comprises the movement direction of the person;
determining at least one angle estimate of a difference between the three-dimensional orientation of the mobile device and the at least one dominant movement direction on the basis of the at least one feature; and
adjusting the acquired EMF measurement results on the basis of the determined at least one angle estimate.

16. A computer program product embodied on a distribution medium readable by a computer and comprising program instructions which, when loaded into an apparatus, execute the following:
acquiring Earth's magnetic field, EMF, measurement results indicating the EMF measured by a mobile device in a building, wherein the EMF measurements are performed by the mobile device in an unknown three-dimensional orientation in a three-dimensional coordinate system of a person carrying the mobile device along a movement direction of the person;
acquiring motion data of the mobile device, wherein the motion data is measured by at least one inertial measurement unit comprised in the mobile device;
extracting at least one feature from the acquired motion data, wherein at least one feature is related to at least one dominant movement direction of the mobile device in a three-dimensional coordinate system of the mobile device, and the at least one dominant movement direction comprises the movement direction of the person;
determining at least one angle estimate of a difference between the three-dimensional orientation of the mobile device and the at least one dominant movement direction on the basis of the at least one feature; and
adjusting the acquired EMF measurement results on the basis of the determined at least one angle estimate.
